(19) United States
(12) Patent Application Publication
(10) Pub. No.: US 2005/0247847 A1
(43) Pub. Date: Nov. 10, 2005

(54) Vehicle mirror assembly mounting plate having contact footings with convex bearing surfaces

(76) Inventors: Heinrich Lang, Ergersheim (DE); Stefan Centmayer, Ergersheim (DE); Jaap-Jan Snel, Ergersheim (DE); Wolfgang Seiboth, Bad Windsheim (DE)

Correspondence Address: MCNAIR LAW FIRM, PA, P.O. BOX 10827, GREENVILLE, SC, 29603-0827, US

(21) Appl. No.: 11/064,980

(22) Filed: Feb. 24, 2005

(30) Foreign Application Priority Data
May 10, 2004 (DE) 202004007411.7

(51) Int. Cl. B60G 1/00; A47F 1/14

(52) U.S. Cl. 248/467

(57) ABSTRACT

A mounting plate for attaching a vehicle mirror assembly to a non-uniform surface of a vehicle body. The plate has an installation side for engaging the vehicle body, and a component side opposite the installation side for carrying components of the mirror assembly. A plurality of contact footings are laterally spaced on the installation side of the plate. Each of the contact footings has a bearing surface protruding beyond a surface plane of the installation side for bearing against the vehicle body when the plate is mounted so that a stable engagement is provided between the plate and the vehicle body on non-uniform surfaces.

### BACKGROUND OF THE INVENTION

1) Field of the Invention

The present invention relates to mounting plates for vehicle mirror assemblies, and more particularly, to a mounting plate of a vehicle mirror assembly having contact footings which include convex bearing surfaces for bearing against a vehicle body to attach the vehicle mirror assemblies to a vehicle body having a slightly non-uniform mounting surface.

2) Description of Related Art

External mirror assemblies on motor vehicles typically consist essentially of two main parts, a mirror holder that is connected to the body of the motor vehicle, and the actual viewing mirror or mirror head which is carried by the mirror holder, often in an adjustable manner. Many mirror assembly varieties include some manner of mounting plate for attaching the mirror assembly to the vehicle. The mounting plate can be characterized as having an installation side facing towards a mounting surface on the vehicle body, and a component side opposite the installation side which carries the viewing mirror and/or other components of a typical mirror assembly. The form of the installation side of the mounting plate is generally adapted to the contour of the vehicle body at the mounting surface to provide a solid flush mount to the vehicle.

It is often desirable to retrofit additional external mirrors to vehicles already in use. However, these additional mirrors do not include mounting plates adapted to match the contour of the new mounting surface of the vehicle body and/or the vehicle body is not contoured to match the shape of the mounting plate. Accordingly, the retrofitting of such additional external mirrors is often overly complicated and leads to poor and improper attachment of the mirror assemblies to the vehicles. Further, adapting the mirror assemblies and vehicles to properly attach the additional mirror assemblies has resulted in increased expense.

The present invention address the problem of adapting the mounting plate to accommodate non-uniform surfaces on the vehicle body to provide a stable connection between the mounting plate and the vehicle body.

### SUMMARY OF THE INVENTION

In summary, the invention is directed to a mounting plate for a vehicle mirror assembly that includes an installation side and a component side opposite the installation side. A plurality of contact footings are carried on the installation side and spatially arranged generally along a periphery of the installation side. A bearing surface is included on each contact footing projecting beyond a surface plane of the installation side for bearing against a vehicle body. The bearing surface has a continuously varying height profile above the surface plane for engaging the vehicle body to accommodate surface variations in the vehicle body. Accordingly, the plate is mounted to the vehicle body so that the contact footings are directed to bear against the vehicle body to provide a stable arrangement between the plate and the vehicle body on non-uniform surfaces.

Preferably, the plate is a generally rectangular semi-rigid plate constructed to flex when mounted to the vehicle for at least partially adapting to surface variations in the vehicle body.

In a further advantageous embodiment of the invention, the contact footings are arranged with one contact footing positioned generally at each corner of the rectangular shaped plate, and the bearing surface of the contact footings is convex. Further, the bearing surface for each contact footing may have the same radius of curvature.

Advantageously, the plate may be a solid molded one piece plate that is non-rigid to adapt to differences in curvature on the surface of the vehicle body when mounted.

In another aspect of the invention, a plurality of securing slots are formed in the plate for receiving fastening members to affix the plate to the vehicle body and allowing adjustable positioning of the fastening members in the slots and further adjustment of the plate for contour matching with the vehicle body. It is preferred that the securing slots be elongated for improved adjustability between the plate, fastening members, and the vehicle body.

In a further embodiment of the invention, it is preferred that the plurality of contact footings includes at least three contact footings spaced across the installation side of the plate for supporting the plate on non-uniform surfaces of the vehicle body.

The invention is further directed to a method for attaching the mounting plate to a non-uniform surface of a vehicle body. The method comprises the steps of providing a plate adapted to flex when stressed to accommodate surface variations in the vehicle body, and the plate including a plurality of contact footings spatially arranged about an installation side of the plate, wherein each contact footing has a bearing surface with a continuously varying height profile projecting from the installation side for engaging the vehicle body and accommodating surface variations in the vehicle body; positioning the plate against the non-uniform surface of the vehicle body with the installation side facing the vehicle body; and, attaching the plate to the vehicle so that the plate is caused to flex and direct the bearing surface of each contact footing against the vehicle body to provide a stable engagement between the plate and the vehicle body for carrying the vehicle mirror assembly.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a perspective view of the mounting plate according to the present invention;

FIG. 2 is a side view of the mounting plate according to the present invention;

FIG. 3a is a side view of the mounting plate prior to installation on a vehicle body according to the present invention; and,

FIG. 3b is a side view of the mounting plate installed on a vehicle body according to the present invention.

### DETAILED DESCRIPTION

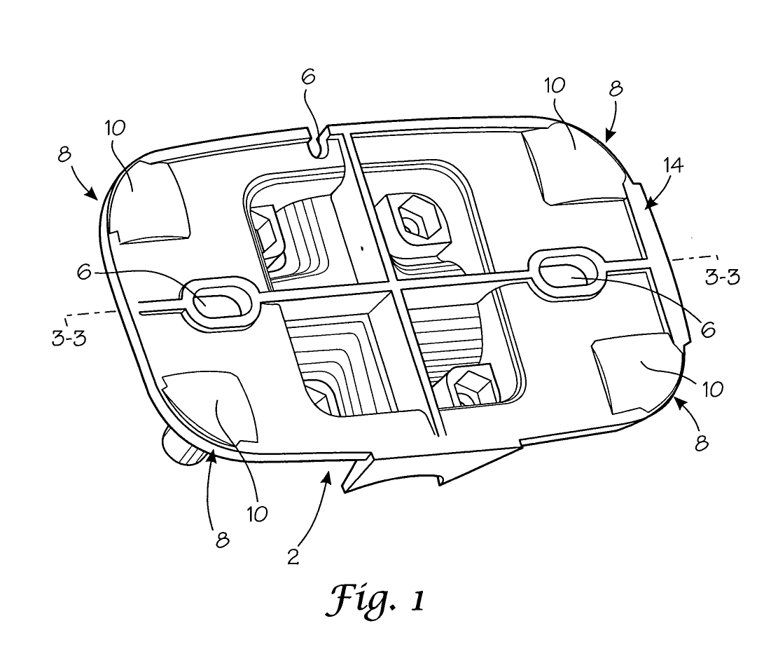

With reference to the drawings, the invention will now be described in more detail. Referring to FIG. 1, a mounting plate, designate generally as 2, is shown for attachment to a vehicle body. Mounting plate 2 is a component of a vehicle mirror assembly which attaches the mirror assembly to the vehicle body. In the embodiment illustrated, mounting plate 2 is a generally rectangular plate. By constructing plate 2 to be semi-rigid for allowing slight flexing and deforming, when the plate is mounted to the vehicle it is able to at least partially adapting to surface variations in the vehicle body. Preferably, mounting plate 2 is made in one piece of a synthetic material that is not torsion rigid to adapt to differences in curvature on the surface of the vehicle body when the plate is mounted. However, the mounting plate may be made from several component pieces so long as the plate retains a semi-rigid state capable of flexing under stress.

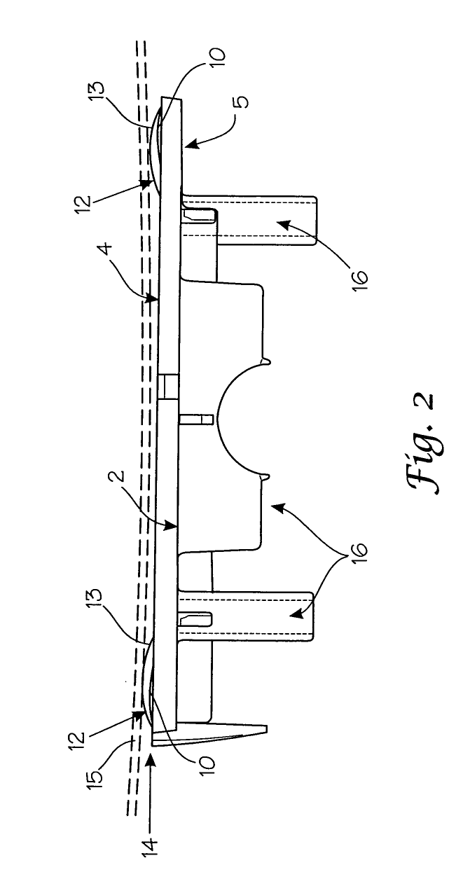

Referring to FIG. 2, mounting plate 2 has an installation side, designated generally as 4, and a component side, designated generally as 5. Installation side 4 is adapted for being mounted against the vehicle body to be retrofitted with the mirror assembly. Installation side 4 is illustrated as having a surface plane 14, designated generally in FIG. 2, which is generally flat and even prior to installation on the vehicle body. Alternatively however, surface plane 14 on installation side 4 may be contoured to be attached to various rounded surfaces of the vehicle body. Component side 5 is opposite the installation side and is adapted to included various connection elements, designated generally as 16, for attaching components of the mirror assembly, such as motors and the like. As best shown in FIG. 1, when mounting plate 2 is molded as a single piece, installation side 4 is countered below surface plane 14 to form the various connecting elements 16 the extend outwardly from component side 5.

Referring to FIG. 1, mounting plate 2 is illustrated as having rounded corners, designated generally as 8. Located generally in the area of each of the four corners 8 of mounting plate 2 are contact footings 10 protruding from installation side 4. While contact footings 10 may be carried at other locations on installation side 4, it is preferred that contact footings 10 be spatially arranged generally along a periphery of installation side 4, and further, that the contact footings be disposed generally at the corners of the plate as illustrated in the Figures, in order to provide the most stable engagement between the contact footings and the vehicle body once the plate is mounted.

Referring to FIG. 2, a bearing surface, designated generally as 12, is included on each contact footing that extends outwardly from installation side 4 beyond surface plane 14 for bearing against the vehicle body. Bearing surface 12 on each contact footing 10 provides a continuously varying height profile 13 having different heights along the bearing surface for engaging a vehicle body 15, indicated in dotted line. As best shown in FIG. 2, in order to create bearing surface 12 with a varying height profile, bearing surface 12 is convex shaped to provide a rounded/spherical surface with different heights above surface plane 14 for engaging the vehicle body. In a further aspect of the invention, convex bearing surface 12 for each contact footing 10 has the same curvature radius so that their manufacture is simplified and the force application on the vehicle body is distributed evenly. Convex bearing surface 12 of contact footings 10 provides an expanded contact surface working in conjunction with the semi-rigid plate construction to compensate for slight non-uniformity in the vehicle body surface 15.

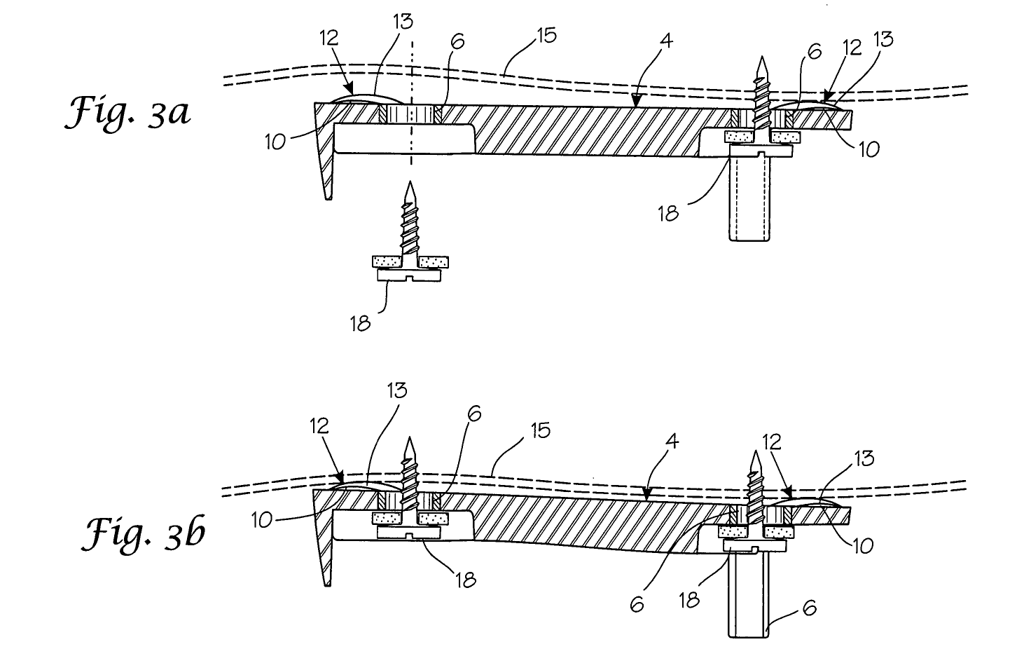

Referring to FIG. 3a, mounting plate 2 is connected to vehicle body 15 by means of at least one fastening member 18, such as screws, bolts and the like. Sheet metal screws 18 are illustrated in FIGS. 3a and 3b, but mounting plate 2 may be secured by any of a variety of ways well know to those skilled in the art. The fastening members engage securing slots 6 integrated in mounting plate 2 to secure the mounting plate to the vehicle. FIG. 3a shows mounting plate 2 before the fastening members 18 are tightened to into the vehicle body. As illustrated in FIG. 3a, not all of the contact footings are engaging vehicle body 15 before fastening members 18 are tightened.

When attaching mounting plate 2 on a vehicle body that is slightly non-uniform, mounting plate 2 is constructed in such a manner and of such a material as to allow the mounting plate to flex and slightly deform when fasting members 18 are tightened to the vehicle, as best shown in FIG. 3b. Accordingly, as fastening members 18 are tightened into vehicle body 15, mounting plate 2 is drawn against the vehicle body until all of the contact footings are directed to bear against the vehicle body. The flexing of the plate allows for all four convex bearing surfaces 12 of contact footings 10 to be placed in contact with vehicle body 15 to provide a stable, solid connection to the vehicle.

As can best be seen in FIG. 3b, plate 2 is mounted to vehicle body 15 so that each contact footing 10 is directed to bear against the vehicle body to provide a stable arrangement between the plate and the vehicle body on non-uniform surfaces for carrying a vehicle mirror assembly. Due to the fact installation side 4 of mounting plate 2 includes a plurality of contact footings 10 with a convex bearing surface 12 separated from each other across the plate and protruding beyond surface plane 14, slight lack of uniformity and slight differences in the curvature of the body are compensated for at the installation location. Together with the not entirely warp resistant construction of the plate, contact footings 10 are directed to bear evenly from against vehicle body 15. Accordingly, mounting plate 2 is prevented from wobbling on the vehicle body. Further, as a result of the variable point by point contact of contact footings 10 at the desired installation location, mounting plate 2 can be mounted on different vehicles without additional modification to the vehicle body or mounting plate. Thus, such a mounting plate for a vehicle mirror assembly is suitable as a universal mounting system for different vehicles. Thereby the desired retrofitting of additional mirrors to a variety of vehicles becomes much less expensive.

While a preferred embodiment of the invention has been described using specific terms, such description is for illustrative purposes only, and it is to be understood that changes and variations may be made without departing from the spirit or scope of the following claims.

1. A mounting plate for attaching a vehicle mirror assembly to a non-uniform surface of a vehicle body, said mounting plate comprising:
a plate having an installation side for engaging the vehicle body, and a component side opposite said installation side for carrying components of the mirror assembly;
a plurality of contact footings laterally spaced on said installation side of said plate; and,
each of said contact footings having a bearing surface protruding beyond a surface plane of said installation side for bearing against the vehicle body when said plate is mounted to accommodate non-uniform surface on said vehicle body.

2. The mounting plate of claim 1 wherein said plate constructed to flex during mounting to the vehicle to direct said bearing surface of said contact footings to engage said vehicle body so that a stable engagement is provided between said plate and said vehicle body on non-uniform surfaces.

3. The mounting plate of claim 1 wherein said bearing surface of each contact footing is convex.

4. The mounting plate of claim 1 wherein said bearing surface for each contact footing is spherical.

5. The mounting plate of claim 1 wherein said bearing surface of each contact footing has the same curvature radius.

6. The mounting plate of claim 1 wherein said plate is a solid molded one piece plate that is non-ridged to accommodate differences in curvature on the surface of the vehicle body when mounted.

7. The mounting plate of claim 1 including a plurality of securing slots formed in said plate for receiving fastening members to affix said plate to the vehicle body and allowing adjustable positioning of said fastening members in said slots and further adjustment of said plate for contour matching with said vehicle body.

8. The mounting plate of claim 1 wherein said plurality of contact footings includes at least three contact footings spaced across said installation side of said plate for supporting said plate on non-uniform surfaces of the vehicle body.

9. A mounting plate for a vehicle mirror assembly, said mounting plate comprising:
a plate having an installation side and a component side;
a plurality of contact footings spatially arranged generally about a periphery of said installation side; and,
a bearing surface included on each contact footing projecting beyond a surface plane of said installation side for bearing against a vehicle body;
said bearing surface having a continuously varying height profile above said surface plane for engaging the vehicle body to accommodate surface variations in the vehicle body;
whereby said plate is mounted to the vehicle body so that said contact footings are directed to bear against the vehicle body to provide a stable arrangement between said plate and the vehicle body on non-uniform surfaces.

10. The mounting plate of claim 9 wherein said plate is a generally rectangular semi-rigid plate constructed to flex when mounted to the vehicle for accommodating surface variations in the vehicle body.

11. The mounting plate of claim 10 wherein said contact footings are arranged with one contact footing positioned generally at each corner of the rectangular shaped plate.

12. The mounting plate of claim 9 wherein said bearing surface is convex.

13. The mounting plate of claim 12 wherein said bearing surface of said contact footings have the same curvature radius.

14. The mounting plate of claim 9 wherein said plate is a solid molded one piece plate that is non-rigid to accommodate differences in curvature on the surface of the vehicle body when mounted.

15. The mounting plate of claim 9 including a plurality of securing slots formed in said plate for receiving fastening members to affix said plate to the vehicle body and allowing adjustable positioning of said fastening members in said slots and further adjustment of said plate for contour matching with said vehicle body.

16. The mounting plate of claim 9 wherein said plurality of contact footings includes at least three contact footings spaced along said periphery of said installation side of said plate for supporting said plate on non-uniform surfaces of the vehicle body.

17. A method for attaching a mounting plate for a vehicle mirror assembly to a non-uniform surface of a vehicle body comprising the steps of:
providing a plate adapted to flex when stressed to accommodate surface variations in the vehicle body, and said plate including a plurality of contact footings spatially arranged about an installation side of said plate, wherein each contact footing has a bearing surface with a continuously varying height profile projecting from said installation side for engaging the vehicle body and accommodating surface variations in the vehicle body;
positioning said plate against the non-uniform surface of the vehicle body with said installation side facing the vehicle body;
attaching said plate to said vehicle so that said plate is caused to flex and direct the bearing surface of each contact footing against the vehicle body to provide a stable engagement between said plate and the vehicle body for carrying the vehicle mirror assembly.

18. The method of claim 17 including providing a plurality of securing slots formed in said plate for receiving fastening members to affix said plate to the vehicle body and allowing adjustable positioning of said fastening members in said slots and further adjustment of said plate for contour matching with said vehicle body, whereby tightening said fastening members to the vehicle body causes said plate to adjust to surface variations in the vehicle body by flexing to direct the bearing surface of each contact footing to engage the vehicle body.

19. The method of claim 17 including providing at least three contact footings spaced along a periphery of said installation side of said plate for supporting said plate on non-uniform surfaces of the vehicle body.

20. The method of claim 17 including providing said bearing surface to be convex.

21. The method of claim 17 including providing said bearing surface of said contact footings to have the same radius of curvature.
